(19) United States
(12) Patent Application Publication
(10) Pub. No.: US 2014/0172455 A1
(43) Pub. Date: Jun. 19, 2014

(54) VISUALIZATION FOR HEALTH EDUCATION TO FACILITATE PLANNING FOR INTERVENTION, ADAPTATION AND ADHERENCE

(71) Applicant: International Business Machines Corporation, Armonk, NY (US)

(72) Inventors: Vincent DENG, Taipei (TW); Mark JH HSIAO, Sindian City (TW); Pei-Yun Sabrina HSEUH, Hawthorne, NY (US); Yi-Fang LEE, Taipei (TW); Sreeram RAMAKRISHNAN, Yorktown Heights, NY (US)

(73) Assignee: International Business Machines Corporation, Armonk, NY (US)

(21) Appl. No.: 13/971,132

(22) Filed: Aug. 20, 2013

Related U.S. Application Data
(63) Continuation of application No. 13/715,029, filed on Dec. 14, 2012.

(51) Int. Cl. G06F 19/00

(52) U.S. Cl. CPC G06F 19/3487
USPC 705/3

(57) ABSTRACT

A method for providing a health visualization model includes receiving user data comprising characteristics corresponding to a user, and adherence data comprising adherence history corresponding to the user, determining a relationship between an adherence level of the user and an expected health outcome based on the user data and the adherence data, generating the health visualization model based on the determined relationship, and outputting the health visualization model.

### CROSS REFERENCE TO RELATED APPLICATIONS

This application is a Continuation Application of U.S. application Ser. No. 13/715,029, filed on Dec. 14, 2012, the disclosure of which is incorporated by reference herein in its entirety.

### BACKGROUND

1. Technical Field

The present invention relates to visualization for health education to facilitate planning for intervention, adaptation and adherence, and more particularly, to a system and method for visualization of health education to facilitate planning for intervention, adaptation and adherence.

2. Discussion of Related Art

The prevalence of lifestyle-related health problems presents a challenge to the national healthcare system. Individual effort is essential for managing the risks of potential diseases before they develop into more serious health problems. Preventative measures taken by high risk individuals can result in the overall reduction in medical care costs.

Studies demonstrate that individuals who monitor the adherence levels of their daily exercise and food intake typically have more success in avoiding the contraction of many chronic diseases. However, existing self-monitoring systems, which rely on non-interactive, manual self-reporting to generate “one shot,” non-real-time feedback from physicians, fitness experts, etc., may not provide an accurate source of information for a user to measure actual adherence. Further, existing self-monitoring systems do not account for interactions among multiple adherence regimens (e.g., a clinical adherence regimen, an exercise adherence regimen, and a nutritional adherence regimen), and do not provide continuous feedback reflecting changes of user preference and circumstance.

### BRIEF SUMMARY

According to an exemplary embodiment of the present invention, a method for providing a health visualization model includes receiving user data comprising characteristics corresponding to a user and adherence data comprising adherence history corresponding to the user, determining a relationship between an adherence level of the user and an expected health outcome based on the user data and the adherence data, generating the health visualization model based on the determined relationship, and outputting the health visualization model.

The adherence data may include a plurality of adherence data types, each data type corresponding to a different area of adherence.

The plurality of adherence data types may include a first data type corresponding to clinical adherence, a second data type corresponding to nutritional adherence, and a third data type corresponding to physical activity adherence.

The first data type may include a recommended medication dosage and an adherence score representing the user's adherence to the recommended medication dosage. The second data type may include a recommended daily caloric intake and an adherence score representing the user's adherence to the recommended daily caloric intake. The third data type may include a recommended exercise frequency and an adherence score representing the user's adherence to the recommended exercise frequency, or a recommended exercise duration and an adherence score representing the user's adherence to the recommended exercise duration.

The method may further include receiving a health goal, determining an optimal nutritional adherence level and an optimal physical activity adherence level for reaching the health goal based on the determined relationship, generating a nutritional adherence suggestion based on the optimal nutritional adherence level and a physical activity adherence suggestion based on the optimal physical activity adherence level, and outputting the nutritional adherence suggestion and the physical activity adherence suggestion.

The nutritional adherence suggestion may include a suggested decrease amount of daily caloric intake, and the physical activity adherence suggestion may include a suggested increase amount of exercise frequency or a suggested increase amount of exercise duration.

The method may further include receiving a health goal, determining an optimal adherence level for reaching the health goal based on the determined relationship, generating an adherence suggestion based on the optimal adherence level, and outputting the adherence suggestion.

The method may further include detecting an inflection point of the health visualization model, generating an alert based on the inflection point, and outputting the alert.

According to an exemplary embodiment of the present invention, a computer program product for providing a health visualization model, the computer program product comprising a computer readable storage medium having program code embodied therewith, the program code executable by a processor, to perform a method including receiving user data comprising characteristics corresponding to a user and adherence data comprising adherence history corresponding to the user, determining a relationship between an adherence level of the user and an expected health outcome based on the user data and the adherence data, generating the health visualization model based on the determined relationship, and outputting the health visualization model.

### BRIEF DESCRIPTION OF THE SEVERAL VIEWS OF THE DRAWINGS

The above and other features of the present invention will become more apparent by describing in detail exemplary embodiments thereof with reference to the accompanying drawings, in which:

FIG. 1A shows a health visualization model generated by a health visualization system, according to an exemplary embodiment of the present invention.

FIGS. 1B and 1C show exemplary adherence relationships for two different patients with reference to the health visualization model of FIG. 1A.

FIG. 2 is a flowchart showing a method of generating a health visualization model, according to an exemplary embodiment of the present invention.

FIG. 3 shows a health visualization model generated by a health visualization system, according to an exemplary embodiment of the present invention.

FIG. 4 is a flowchart showing a method of generating a health visualization model, according to an exemplary embodiment of the present invention.

FIGS. 5A and 5B show health visualization models generated by a health visualization system, according to exemplary embodiments of the present invention.

FIG. 6 is a flowchart showing a method of generating a health visualization model, according to an exemplary embodiment of the present invention.

FIG. 7 is a flowchart showing a method of building a reference database of the relationship between different adherence levels and expected health outcomes, according to an exemplary embodiment of the present invention.

FIG. 8 shows an exemplary computer system for generating a health visualization model, according to an exemplary embodiment of the present invention.

### DETAILED DESCRIPTION

Exemplary embodiments of the present invention now will be described more fully hereinafter with reference to the accompanying drawings. This invention, may however, be embodied in many different forms and should not be construed as limited to embodiments set forth herein.

According to exemplary embodiments of the present invention, a personalized health visualization model is generated and presented to a user (e.g., a patient). The health visualization model allows the user to quantify the health consequences relating to different levels of adherence in different areas, providing the user with a better understanding of the impact different choices made by the user will have on the user's overall health. Since the visualization model provides users with personalized information in an understandable manner, users may be more motivated to make positive health-related changes in an informed manner, since the user may precisely target specific health-related areas with an understanding of the effects targeting these specific areas will have on his or her overall health.

The personalized visualization model may be generated based on a user profile created using user data, and a user's adherence history created using adherence data.

User data used to create the user profile includes user characteristics (e.g., user information and health information) corresponding to the user. For example, the user data may include, but is not limited to, the user's age, gender, weight, height, body mass index (BMI), cholesterol levels, triglycerides, blood pressure, blood sugar levels, fat to muscle ratio, etc.

Adherence data includes the user's adherence history for different health-related areas. For example, adherence history may include adherence data relating to clinical adherence, nutritional adherence, and physical activity adherence. Clinical adherence may correspond to the user's adherence to a physician prescribed medication regimen, nutritional adherence may correspond to the user's adherence to a dieting regimen (e.g., a physician prescribed dieting regimen), and physical activity adherence may correspond to an exercise regimen (e.g., a physician prescribed exercise regimen). Clinical adherence, nutritional adherence, and physical activity adherence may correspond to user defined regimens, or a combination of physician prescribed and user defined regimens. Adherence data may include recommended activity levels and corresponding adherence levels. For example, clinical adherence data may include a recommended dosage of medicine and a user's adherence to the recommended dosage (e.g., an adherence score may represent the user's adherence). Physical activity adherence data may include a recommended frequency and duration of activity and a user's adherence to the recommended frequency and duration (e.g., an adherence score may represent the user's adherence). Nutritional adherence data may include a recommended daily caloric intake and a user's actual caloric intake (e.g., an adherence score may represent the user's adherence). Although exemplary embodiments are described herein with reference to clinical adherence, nutritional adherence, and physical activity adherence, it is to be understood that user adherence history may include additional types of adherences.

The user profile and user adherence history are based on input received by the user. For example, the user may periodically enter this information into a health visualization system using any type of computing device (e.g., a personal computer, a tablet computer, a smartphone, etc.). The visualization system and corresponding data may reside locally on the user's computing device, or may be remotely accessed from the user's computing device.

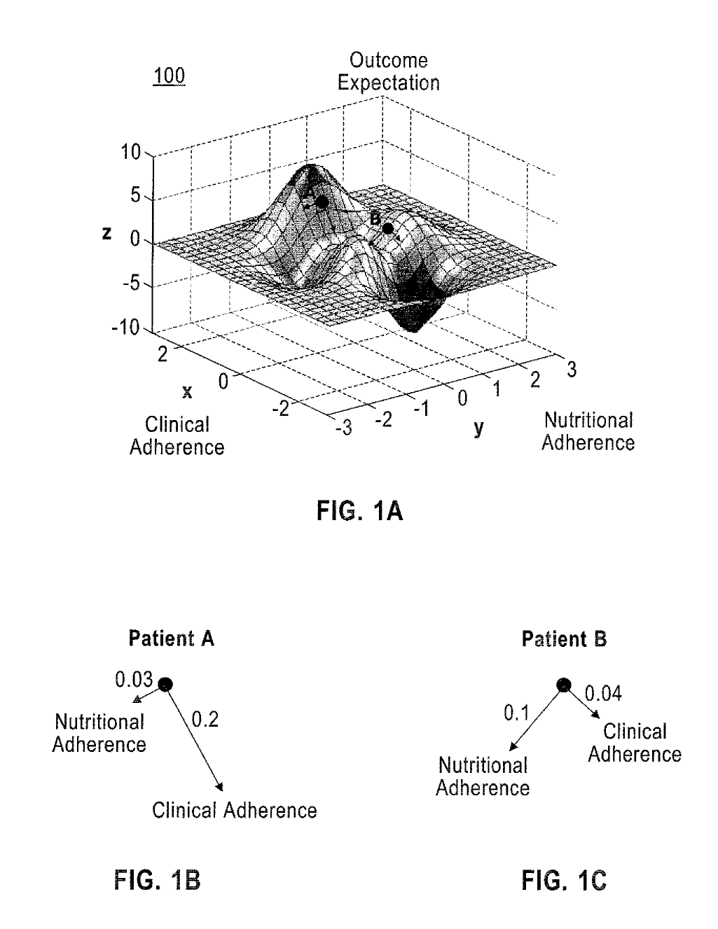

FIG. 1A shows a health visualization model generated by the health visualization system according to an exemplary embodiment. FIG. 1B shows an adherence relationship for a first patient. FIG. 1C shows an adherence relationship for a second patient.

As shown in FIG. 1A, the health visualization model 100 displays an outcome expectation function, which reveals the relationship between a user's health outcome and various adherences (e.g., clinical adherence, nutritional adherence, physical activity adherence). That is, a patient's health improvement is expressed and displayed to the patient as a function of multiple adherence areas. For example, in the health visualization model 100 of FIG. 1A, a patient's health improvement is displayed as a function of clinical adherence and nutritional adherence.

FIG. 1B shows the relationship between clinical adherence and nutritional adherence for a first patient, Patient A. This relationship is overlayed on the health visualization model 100 at point A. As shown, Patient A will receive the most significant health improvement by increasing his or her clinical adherence, as opposed to his or her nutritional adherence. For example, assume that the health visualization model 100 of FIG. 1A represents the patient's HbA1c lab test, which shows the average level of blood sugar of a patient. For Patient A, for every 1% increment in clinical adherence, a 0.2% drop in Patient A's HbA1c level will occur. Comparatively, for every 1% increment in nutritional adherence, only a 0.03% drop in Patient A's HbA1c level will occur. This relationship is clearly presented to Patient A via the visualization model 100. As a result, Patient. A can see that prioritizing his or her clinical adherence over his or her nutritional adherence will result in the most significant health improvement.

FIG. 1C shows the relationship between clinical adherence and nutritional adherence for a second patient, Patient B. This relationship is overlayed on the health visualization model 100 at point B. As shown, Patient B will receive the most significant health improvement by increasing his or her nutritional adherence, as opposed to his or her clinical adherence. For example, for Patient B, for every 1% increment in nutritional adherence, a 0.1% drop in Patient B's HbA1c level will occur. Comparatively, for every 1% increment in clinical adherence, only a 0.04% drop in Patient B's HbA1c level will occur. This relationship is clearly presented to Patient B via the visualization model 100. As a result, Patient B can see that prioritizing his or her nutritional adherence over his or her clinical adherence will result in the most significant health improvement.

Although the health visualization model 100 of FIG. 1 A shows the relationship between adherences for two different patients with corresponding indicators for each patient, the health visualization model 100 may individually display the relationship between adherences for a single patient, or more than two patients, according to exemplary embodiments.

As shown in FIGS. 1A-1C, providing a user with a health visualization model 100 assists the user in adapting his or her lifestyle choices in a manner that is optimized for the individual user. Utilization of a user-specific profile and user-specific adherence data allows for the generation of a personalized health visualization model 100 tailored to individual patients. This personalization provides guidance to the patient, as the patient is able to quantify the health consequences regarding different adherence areas.

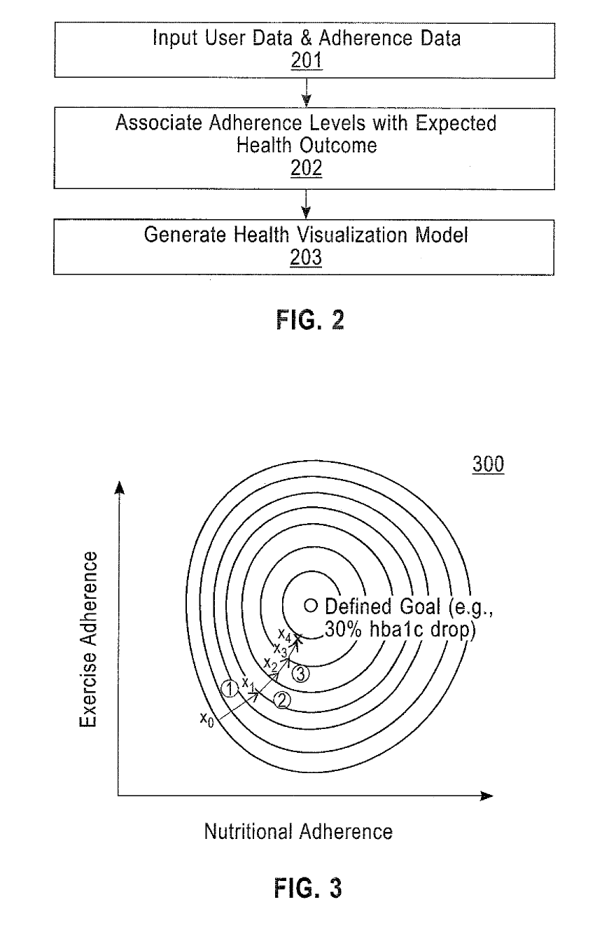

FIG. 2 is a flowchart showing a method of generating a health visualization model using the health visualization system referred to with reference to FIGS. 1A-1C.

At block 201, user data and adherence data are input to the health visualization system. The user data and adherence data may be input to the system by the user, as described above. In addition to initially inputting user data and adherence data, user data and adherence data may be periodically input by the user. For example, as the user progresses with his or her healthcare plan, user data, such as weight, BMI, cholesterol levels, etc., will change. The updated user data may be periodically input by the user or the user's physician. Similarly, as time progresses, adherence data is updated based on the user's adherence in different adherence areas (e.g., clinical adherence, nutritional adherence, physical activity adherence).

At block 202, adherence levels for the different adherence areas are associated with the user's expected health outcome. The correlation between adherence and expected health outcome may be calculated using a variety of suitable modeling methods, including, but not limited to, multiple regression. That is, at block 202, the relationship between adherence in the different adherence areas and the expected health outcome is determined (e.g., the interaction between the different adherence areas and the expected health outcome is determined).

At block 203, a health visualization model (e.g., the health visualization model 100 shown in FIG. 1A) is generated and presented to the user. It is to be understood that the health visualization model is not limited to the model 100 shown in FIG. 1A, and may include any visualization model capable of displaying the relationship between multiple adherence areas and expected health outcome.

Once the visualization model has been presented to the user, the process may return to block 201 to receive updated data from the user (e.g., updated user data and adherence data). The process is repeated each time updated data is received, and the health visualization model generated and displayed at block 203 is updated based on the updated data.

The health visualization model 100 shown in FIG. 1A indicates the relationship between a user's health outcome and various adherences. Such a visualization model provides at-the-moment health education and guidance for a user, permitting the user to make general decisions regarding the prioritization of different adherence levels. In an exemplary embodiment, a health visualization model may display data allowing a patient to devise a long-term health strategy. That is, a visualization model may provide a user with a step-by-step plan that gradually leads a user to a positive health outcome. For example, consider the visualization model 300 shown in FIG. 3. In this visualization model 300, a graph having a bowl shape indicates the relationship between physical activity adherence and nutritional adherence.

Referring to FIG. 3, assume that the defined goal is a 30% drop in the user's HbA1c level. The goal may be entered and changed by the user. In the visualization model 300, the goal (e.g., a 30% drop) corresponds to the bottom/center point of the graph, and point x₀ corresponds to the user's initial HbA1c level. The health visualization system may generate adherence suggestions to the user corresponding to the visualization model 300. The adherence suggestions are based on the optimal adherence level that the user should maintain to reach the goal. The adherence suggestions correspond to the steepest path to the goal for each round. For example, step (1), as indicated in FIG. 3, corresponds to the user transitioning from the initial HbA1c level at point x₀ to a lower HbA1c level at point x₁. Based on the visualization model 300, the fastest and most efficient pathway for a user to transition from point x₀ to point x₁ is for the user to improve his or her physical activity adherence by about 10%, and his or her nutritional adherence by about 5%. Thus, in addition to presenting the user with the visualization model 300, the visualization system may present the user with a healthcare recommendation to improve physical activity adherence by 10% and nutritional adherence by 5%. More specifically, the visualization system may make specific adherence suggestions based on the user's adherence history.

For example, the visualization system may generate a physical activity adherence suggestion directing the user to increase his or her exercise frequency from one day per week to three days per week, or to increase his or her exercise duration from 15 minutes to 30 minutes per jogging activity. The visualization system may generate a nutritional adherence suggestion directing the user to increase the proportion of vegetables in every meal to 30%, or decrease the user's daily caloric intake to 1,600 calories. Once the user has progressed from point x₀ to point x₁, the fastest and most efficient pathway from point x₁ to point x₂ is calculated for step (2) (e.g., the steepest path from point x₁ to point x₂ is determined). Based on the visualization model 300, the fastest and most efficient pathway for a user to transition from point x₁ to point x₂ is for the user to improve his or her physical activity adherence by about 5%, and his or her nutritional adherence by about 5%. Thus, the visualization system may present the user with a healthcare recommendation to improve physical activity adherence by 5% and nutritional adherence by 5%. This process continues as the user progresses towards the bottom/center point of the graph, which represents the user's goal.

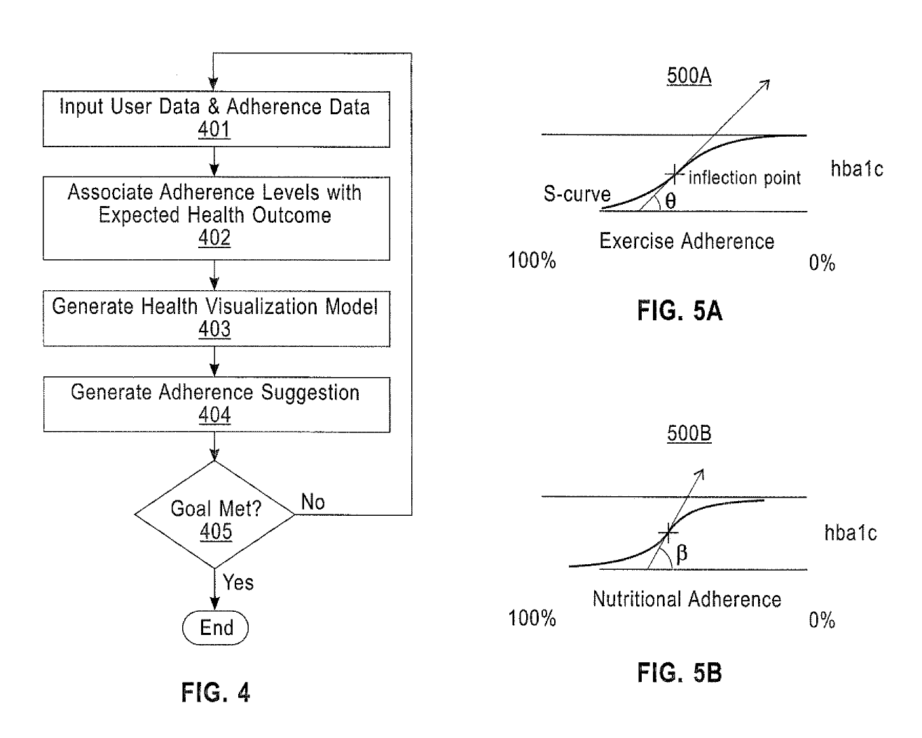

FIG. 4 is a flowchart showing a method of generating a health visualization model using the health visualization system referred to with reference to FIG. 3.

At block 401, user data and adherence data are input to the health visualization system. The user data and adherence data may be input to the system by the user, as described above. In addition to initially inputting user data and adherence data, user data and adherence data may be periodically input by the user. For example, as the user progresses with his or her healthcare plan, user data, such as weight, BMI, cholesterol levels, etc., will change. The updated user data may be periodically input by the user or the user's physician. Similarly, as time progresses, adherence data is updated based on the user's adherence to the different adherence areas (e.g., clinical adherence, nutritional adherence, physical activity adherence).

At block 402, adherence levels for the different adherence areas are associated with the user's expected health outcome. The correlation between adherence and expected health outcome may be calculated using a variety of suitable modeling methods, including, but not limited to, multiple regression. That is, at block 402, the relationship between adherence in the different adherence areas and the expected health outcome is determined.

At block 403, a health visualization model (e.g., the health visualization model 300 shown in FIG. 3) is generated and presented to the user. It is to be understood that the health visualization model is not limited to the model 300 shown in FIG. 3, and may include any visualization model capable of displaying the relationship between multiple adherence areas and expected health outcome to a user.

At block 404, the health visualization system generates an adherence suggestion. The adherence suggestion includes suggestions for the user corresponding to different adherence areas that will result in the most efficient pathway for the user to reach a defined goal, as described above with reference to FIG. 3.

At block 405, it is determined whether the user has met his or her goal. If the user has not yet met the goal, the process may return to block 401 to receive updated data from the user (e.g., updated user data and adherence data), and the process is repeated until the user has met the goal.

In an exemplary embodiment, a health visualization model may be utilized for intelligent intervention. For example, consider the visualization models 500A and 500B shown in FIGS. 5A and 5B. In FIG. 5A, a user's expected health outcome is displayed relative to the user's exercise adherence. In FIG. 5B, a user's expected health outcome is displayed relative to the user's nutritional adherence. As shown in FIGS. 5A and 5B, as the user's exercise adherence and nutritional adherence decrease, the user's HbA1c level begins to increase. The visualization system may detect the inflection point, which is displayed in the visualization models 500A and 500B to the user, and the system may intervene at the inflection point. For example, the visualization system may alert the user that his or her expected health outcome is expected to dramatically worsen when the user's adherence level decreases to a certain point (e.g., the inflection point θ or β).

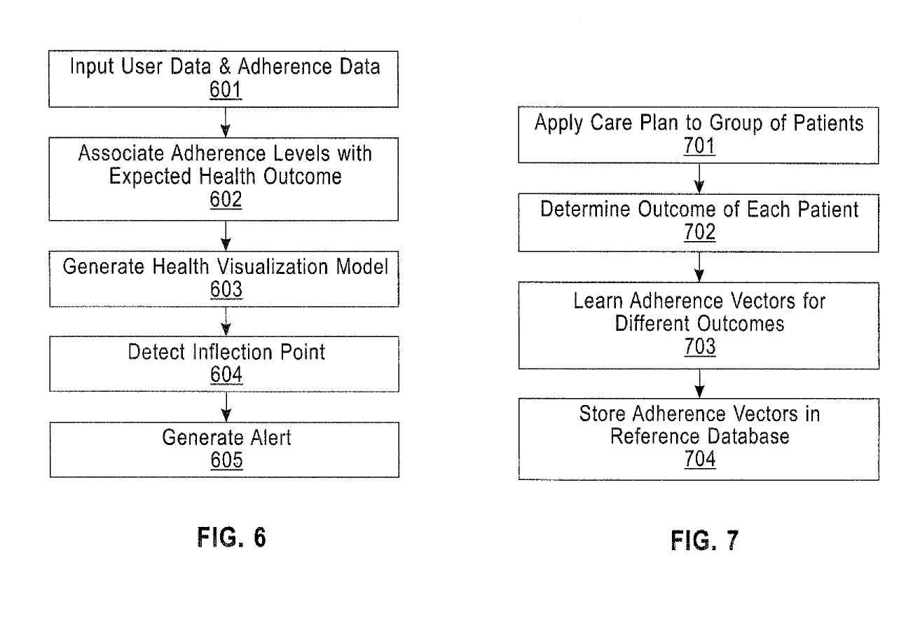

FIG. 6 is a flowchart showing a method of generating a health visualization model using the health visualization system referred to with reference to FIGS. 5A and 5B.

At block 601, user data and adherence data are input to the health visualization system. The user data and adherence data may be input to the system by the user, as described above. In addition to initially inputting user data and adherence data, user data and adherence data may be periodically input by the user. For example, as the user progresses with his or her healthcare plan, user data, such as weight, BMI, cholesterol levels, etc., will change. The updated user data may be periodically input by the user or the user's physician. Similarly, as time progresses, adherence data is updated based on the user's adherence to the different adherence areas (e.g., clinical adherence, nutritional adherence, physical activity adherence).

At block 602, adherence levels for the different adherence areas are associated with the user's expected health outcome. The correlation between adherence and expected health outcome may be calculated using a variety of suitable modeling methods, including, but not limited to, multiple regression. That is, at block 602, the relationship between adherence in the different adherence areas and the expected health outcome is determined.

At block 603, a health visualization model (e.g., the health visualization models 500A and 500B shown in FIGS. 5A and 5B) is constructed and presented to the user. It is to be understood that the health visualization model is not limited to the models 500A and 500B shown in FIGS. 5A and 5B, and may include any visualization model capable of displaying the relationship between multiple adherence areas and expected health outcome.

At block 604, the inflection point is detected in the health visualization model. At block 605, upon detecting the inflection point, an alert is generated and presented to the user informing the user that he or she has reached a point that may soon result in a dramatically worsened health condition if the user continues to decrease his or her adherence level. The process may return to block 601 to receive updated data from the user (e.g., updated user data and adherence data), and the process may be repeated.

FIG. 7 is a flowchart showing a method of building a reference database of the relationship between different adherence levels and expected health outcomes, according to an exemplary embodiment of the present invention.

At block 701, a defined care plan is applied to a group of patients. At block 702, the outcome of each patient is determined. At block 703, an adherence vector is learned for each of the different outcomes. At block 704, the learned adherence vectors or stored in a reference database. This process may be repeated for a plurality of defined care plans. The learned adherence vectors may later be used to predict the health outcome of a specific patient based on the specific patient's adherence levels, as described above. For example, the adherence levels of the specific patient may be monitored over a period of time, and the learned adherence vectors stored in the reference database may then be applied to predict the expected health outcome of the specific patient.

According to exemplary embodiments, an informative and interactive health visualization model may be presented to the user by integrating different types of data. For example, the integration of user data representing physical and medical data corresponding to the patient with different types of adherence data representing the different adherence levels of the patient results in a personalized health visualization model specifically created for that patient. As described above, exemplary embodiments further account for timeline progression on adherence plan effectiveness, and provide adherence data based prediction.

It is to be understood that exemplary embodiments of the present invention may be implemented in various forms of hardware, software, firmware, special purpose processors, or a combination thereof. In one embodiment, a method for generating a health visualization model may be implemented in software as an application program tangibly embodied on a computer readable storage medium or computer program product. As such, the application program is embodied on a non-transitory tangible media. The application program may be uploaded to, and executed by, a processor comprising any suitable architecture.

It should further be understood that any of the methods described herein can include an additional step of providing a system comprising distinct software modules embodied on a computer readable storage medium. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

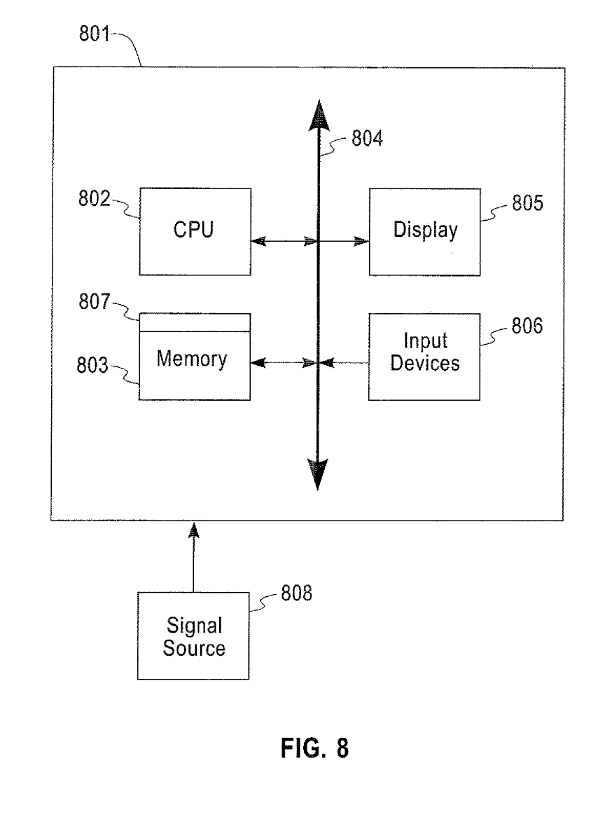

Referring to FIG. 8, according to an exemplary embodiment of the present invention, a computer system 801 for generating a health visualization model can comprise, inter alia, a central processing unit (CPU) 802, a memory 803 and an input/output (I/O) interface 804. The computer system 801 is generally coupled through the I/O interface 804 to a display 805 and various input devices 806 such as a mouse and keyboard. The support circuits can include circuits such as cache, power supplies, clock circuits, and a communications bus. The memory 803 can include random access memory (RAM), read only memory (ROM), disk drive, tape drive, etc., or a combination thereof. The present invention can be implemented as a routine 807 that is stored in memory 803 and executed by the CPU 802 to process the signal from the signal source 808. As such, the computer system 801 is a general-purpose computer system that becomes a specific purpose computer system when executing the routine 807 of the present invention.

The computer platform 801 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described exemplary embodiments for a system and method for generating a health visualization model, it is noted that modifications and variations can be made by persons skilled in the art in light of the above teachings. It is therefore to be understood that changes may be made in exemplary embodiments of the invention, which are within the scope and spirit of the invention as defined by the appended claims. Having thus described the invention with the details and particularity required by the patent laws, what is claimed and desired protected by Letters Patent is set forth in the appended claims.

What is claimed is:

1. A computer program product for providing a health visualization model, the computer program product comprising a computer readable storage medium having program code embodied therewith, the program code executable by a processor, to perform a method comprising:
receiving user data comprising characteristics corresponding to a user, and adherence data comprising adherence history corresponding to the user;
determining a relationship between an adherence level of the user and an expected health outcome based on the user data and the adherence data;
generating the health visualization model based on the determined relationship; and
outputting the health visualization model.

2. The computer program product of claim 1, wherein the adherence data comprises a plurality of adherence data types, each data type corresponding to a different area of adherence.

3. The computer program product of claim 2, wherein the plurality of adherence data types comprise a first data type corresponding to clinical adherence, a second data type corresponding to nutritional adherence, and a third data type corresponding to physical activity adherence.

4. The computer program product of claim 3, wherein the first data type comprises a recommended medication dosage and an adherence score representing the user's adherence to the recommended medication dosage.

5. The computer program product of claim 3, wherein the second data type comprises a recommended daily caloric intake and an adherence score representing the user's adherence to the recommended daily caloric intake.

6. The computer program product of claim 3, wherein the third data type comprises a recommended exercise frequency and an adherence score representing the user's adherence to the recommended exercise frequency.

7. The computer program product of claim 3, wherein the third data type comprises a recommended exercise duration and an adherence score representing the user's adherence to the recommended exercise duration.

8. The computer program product of claim 3, further comprising:
receiving a health goal;
determining an optimal nutritional adherence level and an optimal physical activity adherence level for reaching the health goal based on the determined relationship;
generating a nutritional adherence suggestion based on the optimal nutritional adherence level and a physical activity adherence suggestion based on the optimal physical activity adherence level; and
outputting the nutritional adherence suggestion and the physical activity adherence suggestion.

9. The computer program product of claim 8, wherein the nutritional adherence suggestion comprises a suggested decrease amount of daily caloric intake, and the physical activity adherence suggestion comprises a suggested increase amount of exercise frequency or a suggested increase amount of exercise duration.

10. The computer program product of claim 1, further comprising:
receiving a health goal;
determining an optimal adherence level for reaching the health goal based on the determined relationship;
generating an adherence suggestion based on the optimal adherence level; and
outputting the adherence suggestion.

11. The computer program product of claim 1, further comprising:
detecting an inflection point of the health visualization model;
generating an alert based on the inflection point; and
outputting the alert.
